(19) United States
(12) Patent Application Publication
(10) Pub. No.: US 2001/0035459 A1
(43) Pub. Date: Nov. 1, 2001

(54) Data output device and information-gathering system using the same

(76) Inventor: Takuo Komai, Nagoya-shi (JP)

Correspondence Address: BARNES & THORNBURG, 11 South Meridian Street, Indianapolis, IN, 46204, US

(21) Appl. No.: 09/842,537

(22) Filed: Apr. 25, 2001

(30) Foreign Application Priority Data
Apr. 27, 2000 (JP) 2000-128043

(51) Int. Cl. G06K 7/10

(52) U.S. Cl. 235/462.25

(57) ABSTRACT

A data output device that transmits bar-code data having been read from a bar-code and identification data for specifying the device, and an information-gathering system using the data output device are disclosed. A data output device 12 comprises bar-code reading section 14, data storing section 16, and control section 18. The control section 18 of the data output device 12 transmits information data that is generated by adding identification data, which is previously stored in the data storing section 16 for specifying the data output device 12, to the bar-code data. The data output device 12 is connected to a terminal 30a that can communicate with a communication network 2. Through the communication network 2, the information data is transmitted by the terminal 30a to a host computer 60, which is also connected to the communication network 2, and is stored in data accumulation section 64 of the host computer 60.

### BACKGROUND OF THE INVENTION

1. Field of the Invention

The present invention relates to a data output device comprising means for reading bar-codes corresponding to information, and an information-gathering system using the data output device.

2. Description of the Related Art

Conventionally, bar-code readers have been typically used as input terminals of POS systems in stores for reading a bar-code affixed to each product.

In recent years, such bar-code readers have come to be connected to personal computers (hereinafter referred to as “PCs”) and used as input means therefor.

For example, bar-code data that is read by a bar-code reader connected to a PC is sent to the PC, and a program is executed according to operation instructions corresponding to the bar-code data. In case the bar-code itself contains information, the bar-code data is sent to the PC, is decoded and stored in storing means in the PC.

In the case where the PC can be connected to a communication network such as the Internet, there has been proposed a system in which the user can simply operate a bar-code reader connected to the PC and let it read a bar-code in order to enter a specific URL when the user wants to view a desired file located at that URL on the Internet, instead of making the user type the URL that consists of several tens of letters.

Further, it has recently been considered to perform information exchange and business dealings which require mutual verification on the Internet, such as to order catalogs for specific items or to receive/place orders, by making a user directly access a home page of a manufacturer, or to a computer which serves as a “sales window” of the manufacturer.

Such information exchange and business dealings are to be dealt with immediately, that is, for example, even when the user is having a business talk with his customer or when he is traveling to meet other customers.

The recent spread of mobile terminals such as mobile phones is remarkable, and connection to the Internet using these mobile terminals has become easier and simpler. Unlike PCs which are usually placed in offices and used by a plurality of people, and thus making it difficult to specifically identify who is using the PC, a mobile terminal such as a mobile phone is owned and carried individually by a single user, and this makes it possible to identify the user. Therefore, the present inventor considered performing the above-described information exchange and business dealings by using these mobile terminals.

In the case of a mobile phone for example, although each telephone number is associated with each user (or contractor) and individual information of the user, such as the telephone number, the name, and/or address of a user, is registered to a communication company adjusting the mobile communication, such individual information is not made public. Thus, there is not much difference from the case where a shared desktop PC is used among a plurality of users, since it is not possible to specify the user who transmitted data to, for example, a web-server on the Internet.

Further, although a mobile phone can be connected to the Internet any time when it is within its service area and can immediately perform the above-described information exchange and business dealings, since a mobile phone is compactly designed for mobility, only a limited number of operation keys are provided for each phone, and thus a plurality of functions are allocated to a single key. Thus, for example, when a user wants to order a product online through the Internet using a mobile phone, the user must operate the limited number of keys to enter a considerable number of characters (i.e., numbers or alphabets) expressing individual information such as his name, address and telephone number, along with the information of the product he is wishing to order, such as product name, code number, color specification and an optional setting. Such a complicated operation is time-consuming for the user and there is a possibility of entering wrong data.

Furthermore, although mobile phones have spread among women and the senior citizens, they are usually not accustomed to operating machines. The above-described services requiring complicated operation are inconvenient to them. Thus, they had to use the conventional ordering style where an orderer has to fill in an order sheet and send it by mail or fax, or, where the orderer has to place an order through the phone during the limited hours of operation of a mail-order company.

### SUMMARY OF THE INVENTION

An object of the present invention is to provide a data output device that combines an identification data for identifying a reading device with a bar-code data and transmitting such data, just by reading a bar-code with the reading device. Another object of the present invention is to provide an information-gathering system using the data output device that can accumulate the information data easily and surely through a communication network.

One aspect of the data output device for transmitting information data including bar-code data, which is read from a bar-code, to an external computer according to the present invention comprises: bar-code reading means for reading the bar-code data; data storing means in which identification data for individually specifying the data output device is stored; and control means for transmitting information data which is generated by combining the identification data with the bar-code data read by the bar-code reading means.

The data output device may be connected to a terminal that can communicate with a communication network via a communication interface. It is also possible to incorporate the data output device into the terminal.

Another aspect of the present invention is a system for gathering information comprising: at least one data output device connected to a terminal that can communicate with a communication network, the data output device comprising bar-code reading means for reading bar-code data from a bar-code, data storing means for storing identification data which individually specifies the data output device, and control means for transmitting to the terminal information data which is generated by combining the identification data with the bar-code data; a host computer connected to the communication network, the host computer receiving the information data transmitted from the terminal via the communication network; and data accumulation means, provided in the host computer, for receiving the information data transmitted from the terminal and accumulating the information data therein.

### BRIEF DESCRIPTION OF THE DRAWINGS

For more complete understanding of the present invention and the advantages thereof, reference is now made to the following description taken in conjunction with the accompanying drawings wherein:

FIG. 1 is a schematic view of an applied example for the micro bar-code reader according to one embodiment of the present invention;

FIG. 2 is a schematic view of an information-gathering system using the micro bar-code reader according to one embodiment of the present invention;

FIG. 3 is an inner block diagram of the micro bar-code reader and a mobile phone that is connected thereto according to one embodiment;

FIG. 4 is an inner block diagram of the host computer according to one embodiment; and

FIG. 5 is an external view showing a state of use for the microbar-code reader of an embodiment of the present invention.

### DETAILED DESCRIPTION OF THE PREFERRED EMBODIMENTS

An embodiment of the present invention will be described with reference to the attached drawings as follows.

<Data Output Device>

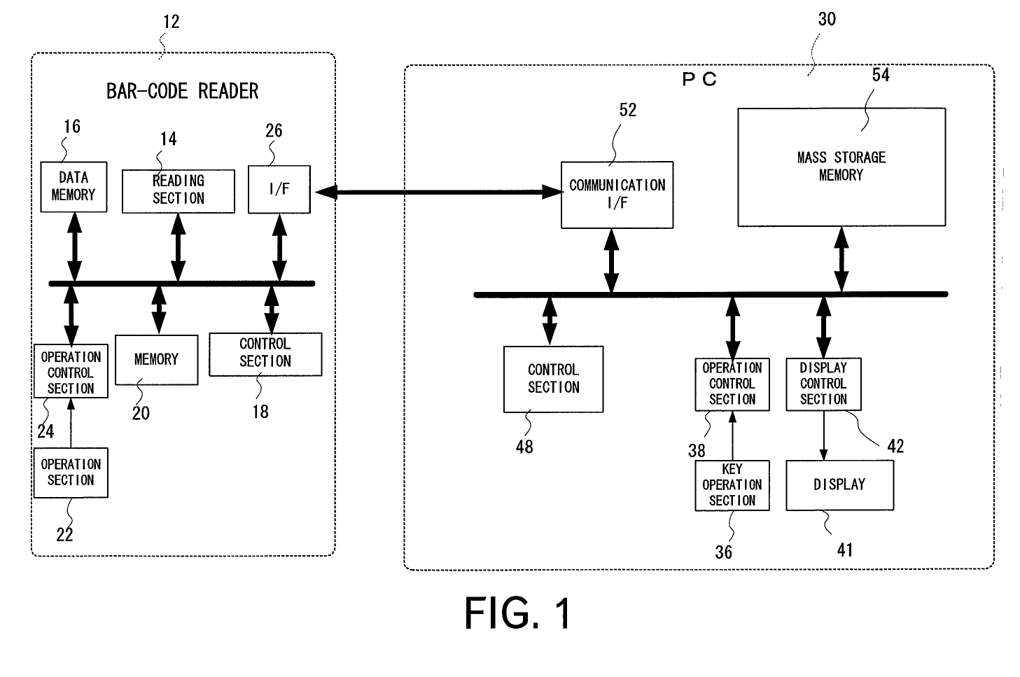

FIG. 1 shows one embodiment of a data output device of the present invention. Description is made for the case where a micro bar-code reader 12, which in this case functions as the data output device, is connected to a stand-alone type PC 30, which functions as an external computer.

A “micro bar-code” is a small-sized bar-code which is approximately 1/20-1/30 the size of a generally used bar-code, and the thinnest black bar is approximately 100 μm in width. It may be, for example, a combination of eight-digit decimals which represent operation commands or identification codes corresponding to information; however, any bar-code format can be used.

The micro bar-code reader 12 comprises an interface 26 connected to the PC 30; a reading section 14 for reading a micro bar-code; a memory 20 for storing the bar-code data having been read; an operation section 22 and operation control section 24 for operating and stopping the reading section 14; a control section 18 comprising micro-computers, a CPU and other such devices for controlling operation of the micro bar-code reader 12; and a data memory 16 where identification data for individually specifying the micro bar-code reader 12 is stored.

The control section 18 turns on the bar-code reading section 14 according to a control signal generated by operation of the operation section and transmitted from the operation control section 24, adds the identification data stored in the data memory 16 to the bar-code data having been read, and sends the bar-code data and the identification data to the PC 30. As the data memory 16, a memory having a backup power source or a non-volatile memory is appropriate. The identification data is generally a product serial number and/or a type number of the micro bar-code reader 12, but it is also possible to use other type of data representing individual information of a user such as the name, address and telephone number which may be previously stored in the memory at the time the micro bar-code reader 12 is purchased.

The PC 30 comprises a communication interface 52 for communicating with the micro bar-code reader 12; a mass storage memory 54 which in this case functions as data accumulation means for accumulating data sent from the micro bar-code reader 12; a key operation section 36 and its operation control section 38; a display 41 for displaying an operation state and/or data stored in the mass storage memory 54, and its display control section 42; and a control section 48 which is provided with a control program and which executes this program.

Once the bar-code data and the identification data are sent from the micro bar-code reader 12, the control section 48 writes the data and “time data”, which indicates the time at which the data was sent out, in the mass storage memory 54 according to a predetermined format. The format may be such where the bar-code data and the identification data are paired and stored in time series according to the time data; or such where the mass storage memory 54 is divided into a plurality of areas for each identification data, and the time data and the bar-code data are paired and stored in each area; or, it may be of any other format. In other cases, the time data does not have to be stored in correspondence with the data.

The micro bar-code reader 12 is to be owned by each individual who uses the PC. The identification data for specifying each individual is stored in the data memory 16 of each micro bar-code reader 12. A user connects his own bar-code reader 12 when operating the reader 12 to read a bar-code and to enter data to the PC 30.

<Applied Example of Data Output Device>

For example, the micro bar-code reader 12 may be used for recording each employee's starting and quitting time. In this case, micro bar-codes that are associated with attendance information such as “attendance”, “out of office”, “back to office”, “left for home” are prepared beforehand, and a communication interface 52 for the bar-code reader 12 is provided for a predetermined PC 30. Data corresponding to each of the employees is previously registered to the PC 30. An employee connects his own bar-code readers 12 to the communication interface 52, and reads the micro bar-code.

At this time, since the identification data of the micro bar-code reader is taken into the mass storage memory 54 along with the bar-code data having been read, the data taken into the mass storage memory 54 can easily be classified into each employee's data. This facilitates creating an attendance record.

It is to be appreciated that the data output device according to the present invention can be used for purposes other than for recording attendance of employees.

<Information-Gathering System>

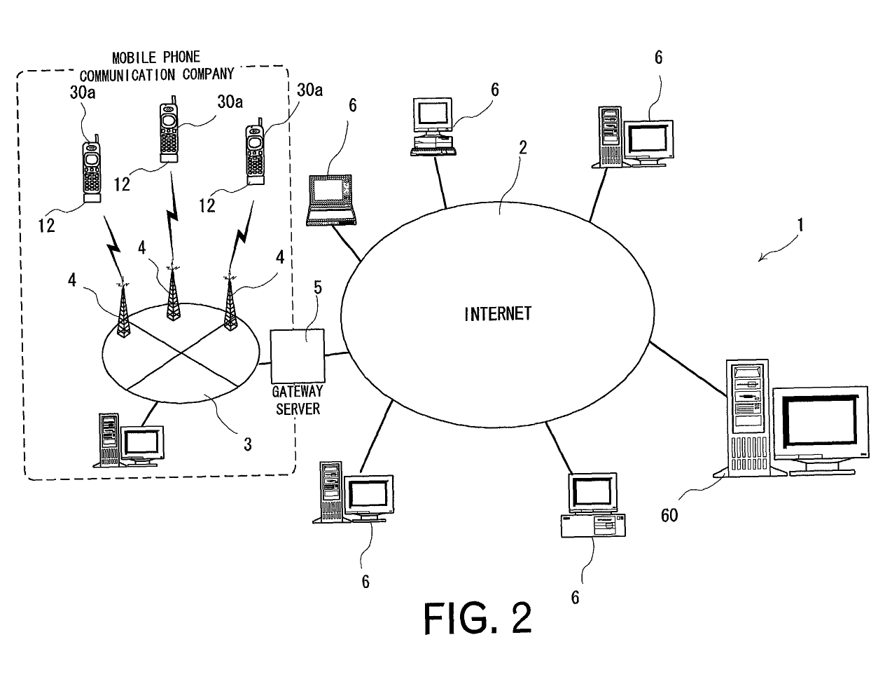

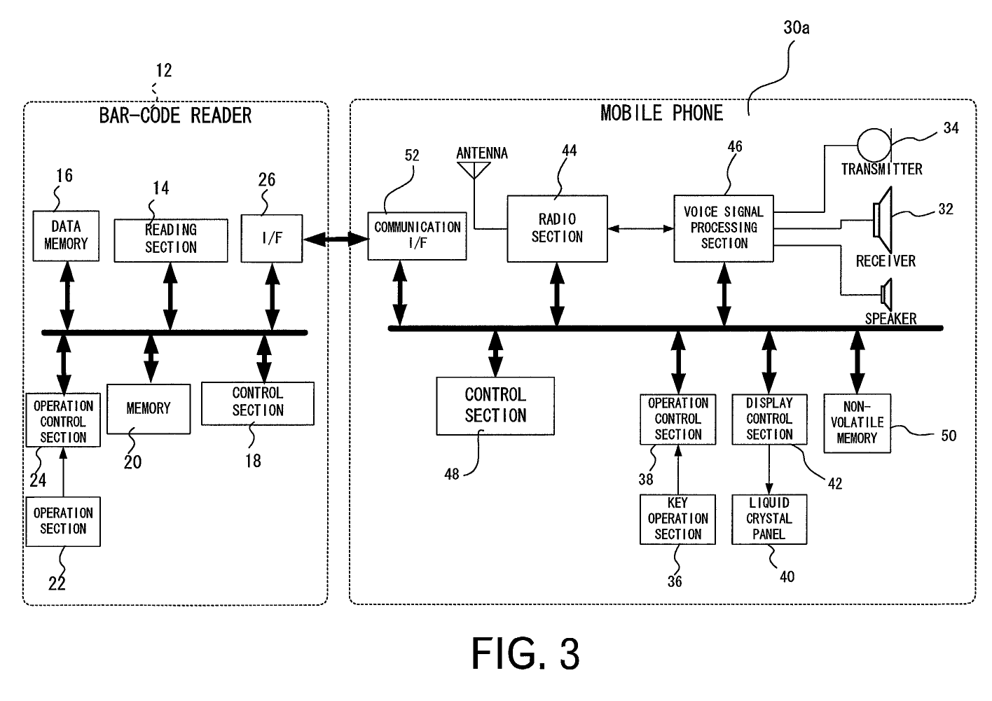

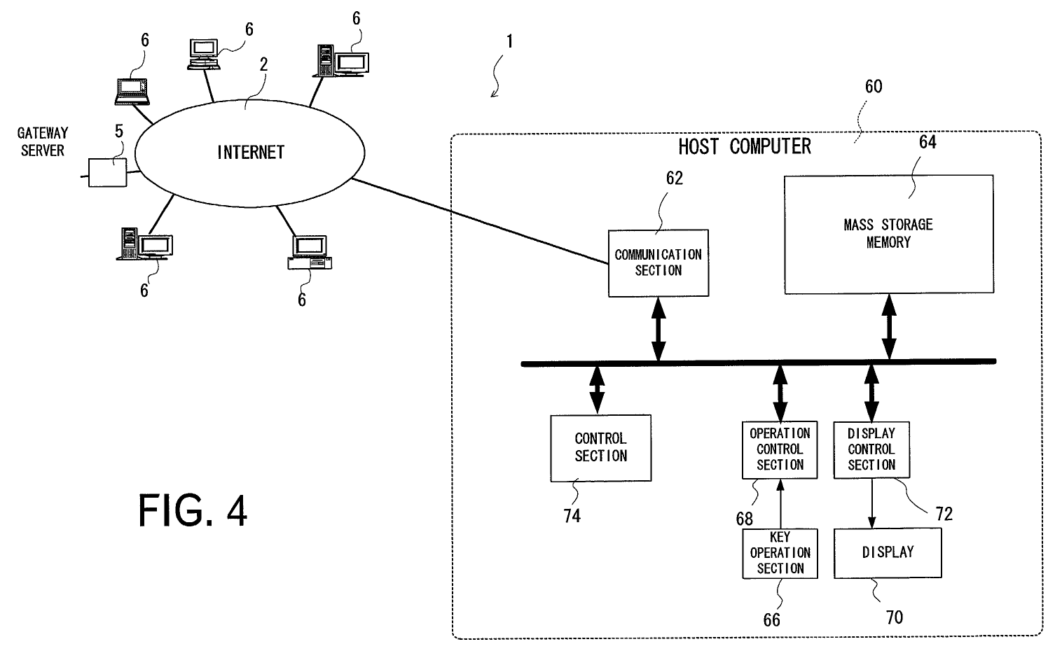

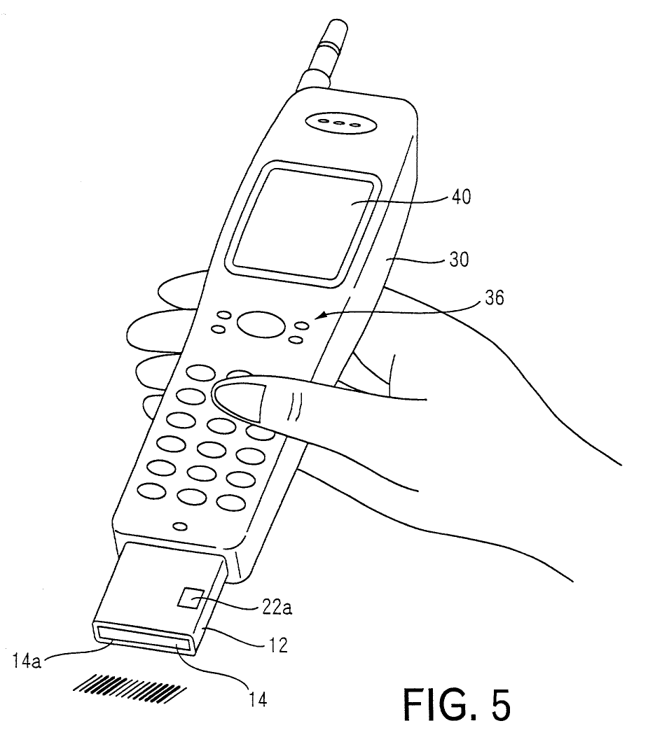

FIG. 2 to FIG. 5 show an embodiment of an information-gathering system using the data output device according to one aspect of the present invention. FIG. 2 is a schematic view including the information-gathering system that uses the data output device of the embodiment. FIG. 3 is an inner block diagram of the data output device of the embodiment and a mobile phone that is connected to the data output device. FIG. 4 is an inner block diagram of a host computer of the embodiment. FIG. 5 is an external view showing a state of use for the data output device of the embodiment of the present invention. In the embodiment, the same reference numerals are assigned to the members that correspond to the ones in the embodiment for the applied example of the above-described data output device 12, and detailed description for those members are omitted.

An information-gathering system 1 according to one aspect of the present invention is realized in the way described below. A micro bar-code reader 12 is connected to a mobile phone 30a which functions as a terminal capable of communicating with the communication network, and the micro bar-code reader 12 functions as a data output device comprising a bar-code reading section 14, a control section 18 which has a function to transfer data to the mobile phone 30a, and a data memory 16 as the data storing means. The micro bar-code reader 12 transmits information data to the mobile phone 30a. Here, the information data is data which is created by adding identification data, which is previously stored in the data memory and used to individually specify the micro bar-code reader 12, to bar-code data having been read by the reading section 14. The mobile phone 30a sends the information data across the communication network. Then, a host computer 60 connected to the communication network stores the information data sent from the mobile phone 30a in its mass storage memory 64 which in this case functions as data accumulation means.

In detail, the communication network may be a network such as the Internet 2, to which a large number of host computers such as WWW servers and mail servers, or user terminals 6 such as a large number of PCs connected through public telephone lines are connected. The Internet 2 is connected to a mobile communication network 3 of a mobile telephone communication company via a gateway server 5. The mobile phone 30a can connect to the mobile communication network 3 through a radio base station 4 of the mobile telephone communication company.

The mobile phone 30a basically comprises: a receiver 32 and a transmitter 34; an externally exposed key operation section 36 functioning as operation entering means, and an operation control section 38 therefor; a liquid crystal panel 40 as displaying means for displaying text and/or graphical images such as HTML documents received via the Internet 2, and display control section 42 therefor; radio section 44 for communication with the mobile communication network 3 via the radio base station 4; a voice signal processing section 46 for converting electric signal to voice and vice versa; a control section 48 which is provided with a control program for the above components and a browser, and which executes these programs ; a non-volatile memory 50 for holding data such as telephone number, mail address and sent/received e-mail, even when no power is fed; and a chargeable battery.

The program installed in the control section 48 is executed by operation of the key operation section, and functions, such as conversation function and connection to the Internet 2 when the browser is activated, are realized.

A communication interface 52 is provided at an end portion of the mobile phone 30a. The communication interface 52 consists of two recharging terminals for supplying power to the rechargeable battery and a signal input/output portion that is located between the two terminals.

The micro bar-code reader 12 is connected to the mobile phone 30a via the communication interface 52 so as to be detachable. Here, the micro bar-code includes information such as operation commands or identification codes that correspond to a URL where a document file is located. Moreover, since the micro bar-code is a compact-sized bar-code, the micro bar-code reader 12, which functions as a reading device for reading the micro bar-code, is an appropriate input means for a compact device such as the mobile phone 30a. The mobility of the mobile phone 30a and the like will not be impaired even when the microbar-code reader 12 is attached to its end portion.

The interface 26 of the micro bar-code reader 12 is connected to the mobile phone 30a.

The control section 18 activates the bar-code reading section 14 according to a control signal generated by operation of an operation key 22a which functions as the operation section 22 and transmitted from the operation control section 24; adds the identification data stored in the data memory 16 to the bar-code data having been read; and sends the bar-code data and the identification data to the mobile phone 30a.

As shown in FIG. 4, the host computer 60 is a specific computer to which the mobile phone 30a, which is connected to the micro bar-code reader 12, accesses through the Internet 2. The host computer 60 comprises: a communication section 62 for the communication with the Internet 2; a mass storage memory 64 as data accumulation means for accumulating entered-data transmitted through the Internet 2; a key operation section 66 and its operation control section 68; a display 70 for displaying operation states and data within the mass storage memory 64, and its display control section 72; and a control section 74 which is provided with a predetermined program and which executes the program.

When the control section 74 is accessed by the mobile phone 30a and receives the bar-code data and the identification data, the control section 74 writes the data and “time data”, which indicates the time at which the host computer was accessed, in the mass storage memory 64 according to a predetermined format. The format may be such where the bar-code data and the identification data are paired and stored in time series according to the time data; or such where the mass storage memory 64 is divided into a plurality of areas for each identification data, and the time data and the bar-code data are paired and stored in each area; or, it may be of any other format. In some cases, the time data does not have to be stored in correspondence with the data.

A program for delivering the data stored in the mass storage memory 64 to a user terminal 6, which is also connected to the Internet 2, may be stored in the control section 74.

<Applied Example of Information-Gathering System>

An applied example of the information-gathering system 1 using the micro bar-code reader 12 is described below. Here, the system 1 is applied to an order receipt-and-placement system used for mail-order.

Here, the order receipt-and-placement system is such for enabling business to be performed between a mail-order company who owns a local terminal (PC terminal) 6 which can be connected to the Internet 2, and individuals who place orders to the mail-order company using their mobile phones 30a which can also be connected to the Internet 2, where in the business is performed via a bar-code management company who owns a host computer 60 that is also connected to the Internet 2.

The mail-order company obtains a considerable number of bar-codes from the bar-code management company, and makes and distributes catalogs on which the bar-codes are printed a long with pictures of products and specifications. On the catalogs, in addition to the bar-codes corresponding to the products, a bar-code which represents the IP address of the host computer 60 and establishes access to the host computer 60 of the bar-code management company when read by a bar-code reader 12, and bar-codes which represent instructions to the mail-order company such as “place an order”, “cancel” and “request for detailed information” are also printed.

On the other hand, a person who wants to purchase a product from the catalog of the mail-order manufacturer (hereinafter called “purchaser”) obtains a personal micro bar-code reader 12 beforehand. A device number data for individually specifying the bar-code reader 12 is inputted in the data memory 16 of the micro bar-code reader 12. The device number is managed by the bar-code management company or the mail-order company. For example, individual information data of the purchaser corresponding to the device number is stored in the database of the host computer 60 of the bar-code management company, or in the terminal of the mail-order manufacturer. In other embodiments, individual data of the purchaser such as name, address, age, sex and, if necessary, a bank account number and a credit card number may also be directly written in the data memory 16 beforehand.

The micro bar-code reader 12 is attached to the purchaser's mobile phone 30a, and then the mobile phone 30a is connected to the Internet 2.

Next, the purchaser makes the bar-code reader 12 read the bar-code printed on the catalog, which corresponds to the IP address of the host computer 60 of the bar-code management company, in order to get connected to the host computer 60. In a state where the connection is established, the purchaser makes the bar-code reader 12 read the bar-code corresponding to a desired article printed on the catalog. When the purchaser wants to purchase the specific article, he consecutively makes the bar-code reader 12 read the bar-code corresponding to the instruction “place an order”. If the purchaser wants to cancel the order for that article, he/she makes the reader 12 read the bar-code corresponding to the instruction “cancel”. Each time the micro bar-code is read, the control section 18 of the micro bar-code reader 12 sends the micro bar-code data, along with the individual information (device number data or individual information data) stored in the data memory 16, to the mobile phone 30a, regardless of whether it is a micro bar-code associated with an article or a micro bar-code associated with an operation instruction. Further, the data is sent from the mobile phone 30a through the Internet, and is stored in the mass storage memory 64 of the host computer 60 of the bar-code management company along with the time data.

According to a predetermined rule, the stored data, after being temporarily copied to a memory of the control section 74 in the host computer 60, maybe transmitted from the host computer 60 of the bar-code management company to the terminal 6 of the mail-order manufacturer; or, the data may be obtained by the terminal 6 of the mail-order manufacturer by accessing to a predetermined area in the host computer 60 of the bar-code management company, to which access from the mail-order manufacturer is permitted.

The mail-order manufacturer who receives the data ships the article corresponding to the received micro bar-code data, to the purchaser specified by the address and name corresponding to the identification data.

Even in the case where the bar-code corresponding to the instruction “cancel” is finally read and no order is placed, the mail-order manufacturer can obtain important marketing information such as the number of access to the article, and age/sex of those who showed interest to the article.

According to the embodiment of the above-described constitution, the identification data that specifies the micro bar-code reader 12 or the user is previously written in the data memory 16 of the micro bar-code reader 12. The identification data is added to the bar-code data each time a micro bar-code is read, then it can be sent out through the Internet 2 from the mobile phone 30a.

Therefore, in the goods dealings that require verification of a purchaser on the Internet 2, those who want to purchase an article can transmit the identification data along with the bar-code data just by reading the bar-code that indicates a desired article using the micro bar-code reader 12, without the need to enter information such as his/her name, address and telephone number separately.

Particularly, since it is a mobile phone 30a to which the micro bar-code reader 12 is connected, the user can order an article immediately from anywhere. Accordingly, for example, in business dealings between a manufacturer and a sales agency, a sales person of the sales agency who is right in the middle of a business talk can cope with an urgent request where he/she must immediately order products to each manufacturer from a place where the sales person is.

Moreover, because the identification data is stored in the data memory 16 of the micro bar-code reader 12 beforehand, there is no possibility that identification data will be erroneously entered at the time of data transmission, thus a correct data can be sent.

The data sent from the mobile phone 30a is stored in the mass storage memory 64 in the host computer 60 of the bar-code management company, and it is temporarily written in a RAM of the control section 74 when the data is to be delivered. Thus, all of the history of receiving/placing orders using the bar-code is accumulated in the host computer 60 of the bar-code management company who is a third party different from either the purchaser or the mail-order company. Therefore, it is possible to prevent illegal dealings and troubles in receiving/placing orders.

In the above-described embodiment, the micro bar-code reader 12 takes a form where it is attachable/detachable to the mobile phone 30a. However, a different embodiment may be taken where the bar-code reading section 14 is built-in the mobile phone 30a to share the control section 18 and the data memory 16 and the like with the mobile phone 30a, and the micro bar-code reader 12 is operated by the key operation section 36 of the mobile phone 30a.

The above embodiment shows an example in which a micro bar-code reader 12, in which a data memory 16 is integrally incorporated, is employed as a data output device. However, the data output device is not limited to this example, and the data memory 16 may be separated from the micro bar-code reader 12 and made to be attachable/detachable, and they may be connected to the mobile phone 30a.

The above embodiment shows a state where the data output device is connected to the mobile phone 30a. However, the data output device may be connected to a PC terminal which can communicate with a communication network such as the Internet 2.

Moreover, there is shown an embodiment where an operation key 22a is provided on the micro bar-code reader 12 as the operation section 22. However, the micro bar-code reader 12 may have a protruded switch on an end portion of the same surface where a light receiving/emitting window 14a of the reading section 14 is provided. The reading section 14 is to be operated by pressing of the switch. With such a form, when the micro bar-code reader 12 is brought close to the bar-coded surface for reading the bar-code, the switch is pushed against the surface, and thus there is no need for an additional operation to push the operation key 22a.

In the above-described embodiments, a micro bar-code is used as the bar-code, but any kind of bar-code can be used.

Further, it is to be appreciated that the information-gathering system according to the present invention can be applied to any other embodiments other than the above-described mail-ordering system.

As described above, in the data output device according to one embodiment of the present invention, the information data, accompanied with the identification data, can be sent to an external computer to which the data is destined. Because the identification data is previously stored in the data storing means, the identification data will not be erroneously entered, and thus a correct data can be sent.

A sender of the data can immediately transmit data from anywhere without entering the identification data separately.

Furthermore, the terminal that receives data (i.e., a recipient) can easily determine the sender of the data, and the sender can inform the recipient of the sender's information without particularly requiring key operation for entering the identification data.

Also according to the information-gathering system of one embodiment of the present invention, the bar-code data and the identification data can be accumulated in the data accumulation means of the host computer which receives the data.

Although the preferred embodiment of the present invention has been described in detail, it should be understood that various changes, substitutions and alternations can be made therein without departing from spirit and scope of the inventions as defined by the appended claims.

What is claimed is:

1. A data output device for transmitting information data including bar-code data, which is read from a bar-code, to an external computer comprising:
bar-code reading means for reading the bar-code data;
data storing means in which identification data for individually specifying the data output device is stored; and
control means for transmitting information data which is generated by combining the identification data with the bar-code data read by the bar-code reading means.

2. The data output device according to claim 1, wherein the data output device is connected to a terminal via a communication interface, the terminal being capable of communicating with a communication network.

3. The data output device according to claim 1, wherein the data output device is incorporated into a terminal that can communicate with a communication network.

4. A system for gathering information comprising:
at least one data output device connected to a terminal that can communicate with a communication network, the data output device comprising bar-code reading means for reading bar-code data from a bar-code, data storing means for storing identification data which individually specifies the data output device, and control means for transmitting information data to the terminal, the information data being generated by combining the identification data with the bar-code data;
a host computer connected to the communication network, the host computer receiving the information data transmitted from the terminal via the communication network; and
data accumulation means, provided in the host computer, for receiving the information data transmitted from the terminal and accumulating the information data therein.

5. The system for gathering information according to claim 4 further comprising at least one local terminal connected to the communication network for receiving the information data accumulated in the data accumulation means in the host computer through the communication network.
